(19) United States
(12) Patent Application Publication
(10) Pub. No.: US 2022/0012846 A1
(43) Pub. Date: Jan. 13, 2022

(54) METHOD OF MODIFYING DIGITAL IMAGES

(71) Applicant: Anthropics Technology Limited, London (GB)

(72) Inventors: Garoe Dorta, Las Palmas (ES); Sara Vicente, London (GB); Neill Campbell, Bath (GB); Ivor Simpson, Brighton (GB)

(21) Appl. No.: 17/290,686

(22) PCT Filed: Nov. 14, 2019
(86) PCT No.: PCT/GB2019/053229

§ 371 Date: Apr. 30, 2021

(30) Foreign Application Priority Data
Nov. 16, 2018 (GB) 1818759.1

(51) Int. Cl. G06T 3/00; G06T 3/40; G06T 7/30; G06N 3/08; G06N 3/04

(52) U.S. Cl. CPC G06T 3/0093; G06T 3/4069; G06N 3/0454; G06N 3/08; G06T 7/30

(57) ABSTRACT

A computer-implemented method for training a generator to manipulate one or more characteristics of an image is disclosed. The method comprises training a generator to output warp fields that modify one or more characteristics of an image, wherein training the generator comprises use of a Generative Adversarial Network (GAN) and training data comprising a plurality of images.

### TECHNICAL FIELD

The present disclosure relates to methods of modifying digital images.

### BACKGROUND

Ever since the advent of digital image processing, a significant amount of research and development has been dedicated to improving a user's ability to make modifications to a digital image. Digital image modification is now an integral part of a wide array of industries, and improving the accuracy, speed and precision of image modification techniques therefore has wide-ranging potential benefits.

Image modification can roughly be grouped into two types—syntactic modification and semantic modification. Syntactic modification relates to modifying aspects of an image that typically do not carry semantic meaning, for example altering the colour, brightness or contrast of an image. Syntactic modification also encompasses adding and removing meaningless objects to an image, for example when “touching up” imperfections in an image. Examples of syntactic image modifications include changing the colour of someone's hair, removing blemishes from their face or increasing the contrast of at least a portion of an image.

Semantic modification, on the other hand, relates to modifying aspects of an image that typically do carry semantic meaning. Semantic modifications therefore typically change the meaning of an image to a far greater extent than syntactic modifications. Examples of semantic image modifications include modifying a person's expression so that they exhibit a different emotional state. For example, an image of a person who is not smiling can be modified so that they are smiling, or vice versa.

As computer processing capabilities have advanced, it has become possible to automate digital image modification to a large extent. However, automating syntactic image modification is typically far less complex than automating semantic image modification. As a result, whereas automatic syntactic image modification (for example “auto-contrast” and “auto-colour” functionality) has been widely available for some time across a wide array of platforms, the ability to quickly and efficiently make semantic modifications to digital images remains lacking.

Some progress in the field of automatic semantic image modification has been made more recently, largely as a result of the increased possibility of using machine learning, which can enable computer systems to rapidly “learn” how to make semantic image modifications. However, significant shortcomings still remain.

One significant drawback of existing semantic image modification systems is the fact that existing systems are often limited in terms of the resolution at which they can perform image modifications. When machine learning techniques are used, the computer system (known as the “generator” in the art) being trained to perform automatic image modifications is trained on training data. This training data typically comprises a large number (often many thousands) of images exhibiting the characteristic that the generator is learning to modify to or from. From this training data, the generator “learns” how to make one or more particular semantic modifications by modifying that characteristic. Given the large number of images that are required to train the generator in this way, the resolution of the training images must be severely limited to avoid placing an unmanageable level of processing burden on the generator and the training environment as a whole. This means that the generator “learns” to perform image modifications at a limited resolution. Traditionally, modifications learnt in this manner cannot then subsequently be scaled up to arbitrary resolutions. This severely limits the utility and applicability of such systems, because it means that the learnt modifications cannot be applied to images at higher resolutions than the training data. There is thus a need for image modification techniques that are scalable to arbitrary resolutions, regardless of the resolution of the training data used to train the generator.

Another drawback of existing systems is that they often require paired training data. For example, taking the case of altering the expression of an image subject from smiling to not smiling, in order to train a generator to modify images in this way using many existing systems the generator must be trained on many pairs of images. Each pair of images in this case shows the same person, in one image smiling and in the other image not smiling. Many such image pairs must be obtained and provided to the generator during training. Typically, other features of the image, such as the background, must be kept consistent across each image pair. The generator of such systems is then trained by transforming a smiling image into its non-smiling pair.

In order to obtain paired training data of this sort, multiple candidates are typically required to take part in a highly controlled photoshoot, such that two images differing only in the characteristic in question (for example smiling and not smiling) can be taken. Clearly, this means that obtaining training data is very burdensome. This in turn tends to reduce the number of training images available, hampering the generalisability and effectiveness of the trained model. There is therefore a need for image modification techniques that can employ unpaired training data, in other words training data that does not require two (or more) images of the same subject in a highly controlled setting to be provided.

It would be advantageous to provide systems and methods which address one or more of the above-described problems, in isolation or in combination.

### BRIEF DESCRIPTION OF THE FIGURES

Illustrative implementations of the present disclosure will now be described, by way of example only, with reference to the drawings. In the drawings:

FIG. 1 shows a training process for training a generator to output warp fields that modify one or more characteristics of an image according to the present disclosure;

FIG. 2 shows an overview of a method for modifying images according to the present disclosure using a generator trained according to the method of FIG. 1;

FIG. 3 shows a schematic representation of a computer system that may be used to perform the methods of the present disclosure, either alone or in combination with other similar computer systems;

FIGS. 4a and 4b show a first exemplary image modification produced by the application of the disclosed methods. FIG. 4a shows a real image of a person, the image belonging to a first (non-smiling) domain. FIG. 4b shows a fake image of the same person, the image belonging to a second (smiling) domain. FIG. 4b was produced by applying a warp field generated using the disclosed methods to the image of FIG. 4a.

FIGS. 5a to 5c show a second and third exemplary image modification produced by the application of the disclosed methods. FIG. 5a shows a real image of a person, the image belonging to a first (small nose) and second (eyes open) domain. FIG. 5b shows a fake image of the same person, the image belonging to a third (large nose) domain. FIG. 5b was produced by applying a warp field generated using the disclosed methods to the image of FIG. 5a. FIG. 5c shows a fake image of the same person, the image belonging to a fourth (eyes narrowed) domain. FIG. 5c was produced by applying a different warp field generated using the disclosed methods to the image of FIG. 5a.

Throughout the description and the drawings, like reference numerals refer to like features.

### DETAILED DESCRIPTION

The present disclosure provides an improved method of modifying digital images. By using the methods of the present disclosure, realistic image modifications may be obtained at high resolutions and without any need for paired or controlled training data. This is in contrast to existing image modification systems.

According to an aspect of the present disclosure, a computer-implemented method for training a generator to manipulate one or more characteristics of an image is disclosed. The method comprises training a generator to output warp fields that modify one or more characteristics of an image, wherein training the generator comprises use of a Generative Adversarial Network (GAN) and training data comprising a plurality of images.

According to a further aspect of the present disclosure, a computer-implemented method for manipulating one or more characteristics of an image is disclosed. The method comprises receiving input image data from an input image at a trained generator, wherein the generator is trained, through use of a Generative Adversarial Network (GAN) and training data comprising a plurality of images, to output warp fields that modify one or more characteristics of an image. The method further comprises generating, by the trained generator and based on the input image data, a warp field. The method further comprises applying the warp field to a candidate image to modify one or more characteristics of the candidate image and outputting the modified candidate image.

According to another aspect of the present disclosure, a computer-implemented method for manipulating one or more characteristics of an image is disclosed. The method comprises training a generator to output warp fields that modify one or more characteristics of an image, wherein training the generator comprises use of a Generative Adversarial Network (GAN) and training data comprising a plurality of images. The method further comprises providing input image data from an input image to the trained generator and generating, by the trained generator and based on the input image data, a warp field. The method further comprises applying the warp field to a candidate image to modify one or more characteristics of the candidate image and outputting the modified candidate image.

A warp field can be considered as an image deformation field which describes spatially localised geometric transformations, in other words a set of displacement vectors, one per pixel. When the warp field is applied to an image, the displacement vectors act on corresponding pixels of the image to displace them and thus cause a modification of the image. A warp field can also be considered to describe a mapping of the points (pixels) of an image from a first location (in the original image) to a second location (in the modified image). The mapping can be an identity mapping for one or more of these points in which case the mapping has no affect at those points.

Optionally, the generator is trained to output warp fields that modify one or more characteristics of an image to match a set of target characteristics. In this case, a set of target characteristics is provided to the trained generator along with the input image data, and applying the warp field to a candidate image modifies one or more characteristics of the candidate image to match the target characteristics.

Optionally, modifying one or more characteristics of the candidate image comprises transforming one or more characteristics of the candidate image from a first domain to a second domain. A domain may be considered as a set of images sharing a common semantic characteristic. The training data optionally comprises a plurality of images each having semantic image characteristics from either the first domain or the second domain. For example, the training data may comprise a first plurality of images showing people not smiling, and a second plurality of images showing people smiling. Advantageously, the images in the first plurality can be completely unrelated to the images in the second plurality, in other words the training data need not comprise paired images.

The method may further comprise aligning the input image data with the training data prior to providing the input image data to the trained generator. Aligning the input image data with the training data in this way can help improve the correspondence between the input image data and the warp fields that the generator has learnt to produce during training. Aligning the input image data with the training data optionally comprises applying a first alignment transformation to the input image data. Aligning the input image data with the training data optionally comprises modifying the resolution of the input image data from a first resolution to a second resolution, wherein the first resolution is the resolution of the input image and the second resolution is preferably similar (for example within a pre-determined threshold of) or the same as the resolution of the training data. The various images making up the training data itself can also be aligned in this way, prior to the input data being aligned with the training data.

Optionally, the warp field is aligned with the candidate image prior to applying the warp field to the candidate image. Aligning the warp field with the candidate image in this way can help improve the correspondence between the warp field and the candidate image, such that the local deformations described by the warp field are applied to the appropriate portions of the candidate image. Aligning the warp field with the candidate image optionally comprises applying a second alignment transformation to the input image data, wherein the second alignment transformation may be an inverse of the first alignment transformation. Aligning the warp field with the candidate image optionally comprises modifying the resolution of the warp field from the second resolution to a third resolution, wherein the third resolution is the same as the resolution of the candidate image. The third resolution may be the same as the first resolution. Typically, but not necessarily, the candidate image is the same as the input image, in other words the warp field generated based on the input image data obtained from the input image is then applied to said input image.

The first and/or second alignment transformation may comprise a linear transformation. Advantageously, such linear transformations may be estimated easily, robustly, are trivially invertible and may help to prevent inducing large distortions of the input image data or warp field being aligned respectively. The first and/or second alignment transformation may alternatively comprise a non-linear transformation which may allow localised deformations.

The method may further comprise obtaining landmark image data from the input image. The input image data may then comprise said landmark image data associated with the input image. Using landmark image data may provide additional information to the generator regarding the pose of the object in the image. Advantageously, using said landmark image data can help to improve the effectiveness of the trained generator. Landmark image data can also be used during the estimation of the first and/or second alignment transformations described above. When the image being modified comprises a human face, the landmark image data may comprise human facial landmark data and may be obtained using human facial landmark recognition software.

Optionally, the warp field is regularised such that the warp field is restricted to comprising displacement vectors that only change incrementally (for example within a pre-determined threshold) with respect to neighbouring pixels. Regularising the warp field helps to ensure that the warp field is smooth, which advantageously means that the warp field may be upscaled more easily to arbitrarily large resolutions. Optionally, the warp field is regularised by penalising a function of the warp field gradients, in other words the difference in magnitude and direction of neighbouring displacement vectors. One example of such a regularisation is an L2 gradient penalty loss. Optionally, the relative change in position of neighbouring pixels when they are warped is limited to be within a pre-determined threshold. Optionally, regularisation of the warp field is achieved by an alternative function of the warp field gradients, such as total variation.

Optionally, the generator learns to produce an intermediate warp representation based on its training, wherein the intermediate warp representation comprises a vector of numbers that, when passed through a pre-defined warp field generating function, defines the warp field. The generator may learn to produce an intermediate warp representation that defines a warp field configured to enable the production of realistic edits of image characteristics.

Optionally, the intermediate warp representation comprises one of: an offset vector per pixel; offset vectors for a sparse set of control points. In other words, the warp field is optionally parametrised by one of: an offset vector per pixel; offset vectors for a sparse set of control points. Offsets may also be considered as displacement vectors. Each specified intermediate warp representation may have an associated warp field generating function. The choice of intermediate warp representation may determine specific intrinsic properties of the resulting warp fields, for example the flexibility or smoothness of the warp field. In some implementations, the intermediate warp representation comprises displacement vectors (offsets) defined for every pixel in the warp field. This is the case where the warp field is parametrised by an offset per pixel, for example.

Where an intermediate warp representation defines an offset (i.e. a displacement vector) for every pixel, the intermediate warp representation already represents a fully defined warp field. In this case the warp field generating function performs no operation when acting on the intermediate warp representation. In other words, for a fully dense intermediate warp representation, the warp field generating function outputs its input without modification such that, where the intermediate warp representation is represented by g and the warp field generating function is represented by w, then w(g)=g.

It will be appreciated that the intermediate warp representation does not need to be so fully defined, however. In other words, the intermediate warp representation can in some implementations define a sparse set of displacement vectors, in other words a set of displacement vectors for only a sparse set of pixels. This is the case where the intermediate warp representation comprises offsets for a sparse set of control points, for example.

When the intermediate warp representation comprises offsets for a sparse set of control points, the intermediate warp representation does not represent a fully defined warp field and so the warp field generating function interpolates the sparse set of input displacement vectors to produce a warp field that defines a displacement vector for every pixel. In this manner a fully defined warp field is generated from an intermediate warp representation. In some implementations this is achieved through the use of thin plate spline interpolation. The sparse set of control points optionally comprises landmark image data, in other words comprise the points of an image identified by landmark image data. It will be appreciated that, where the intermediate warp representation is represented by g and the warp field generating function is represented by w, then w(g)≠g for a sparsely defined intermediate warp representation, because g is interpolated to create the fully defined warp field.

It will be appreciated that there are advantages and disadvantages to the different intermediate warp representations that can be used to generate the warp field. Generating a warp field from a sparse intermediate warp representation is less computationally expensive, because the generator needs to define fewer displacement vectors. However, a dense intermediate warp representation allows more flexibility, because the displacement vectors for more pixels are already pre-determined and are not determined by interpolation. An advantage of the methods of the present disclosure is that the degree to which the intermediate warp representation produced by the generator is sparse or dense can be varied according to the needs of a specific implementation. In some cases, computational efficiency may be valued over flexibility, and vice versa.

Training the generator to output warp fields may further comprise performing, by the GAN, cycle-consistency checks. This advantageously helps ensure that the generator tends towards learning reversible transformations, in other words producing invertible warp fields. This in turn means that the generator tends towards generating warp fields that are smooth (because invertible warp fields are by definition smooth) and that therefore, when applied to images, cause realistic modifications of the images. Cycle-consistency checks also make it easier for the model to learn coherent ways to apply and remove particular modifications. It also improves the stability of training the model.

Optionally, the GAN is a StarGAN. Optionally, the generator is implemented as a computer program using a neural network, such as a deep neural network.

Optionally, at least one of the input image and the candidate image comprises a human face.

According to a further aspect of the present disclosure, computer-executable instructions are disclosed which, when executed on a computer, cause the computer to perform one or more of the methods described herein.

According to a yet further aspect of the present disclosure a computer comprising a processor and memory is disclosed, wherein the memory comprises computer-executable instructions which, when executed, cause the computer to perform one or more of the methods described herein.

According to a yet further aspect of the present disclosure, a computer program is disclosed comprising computer-executable instructions which, when executed, cause the computer to perform one or more of the methods described herein.

According to a yet further aspect of the present disclosure, a computer readable medium is disclosed comprising a computer program which comprises computer-executable instructions which, when executed, cause a computer to perform one or more of the methods described herein.

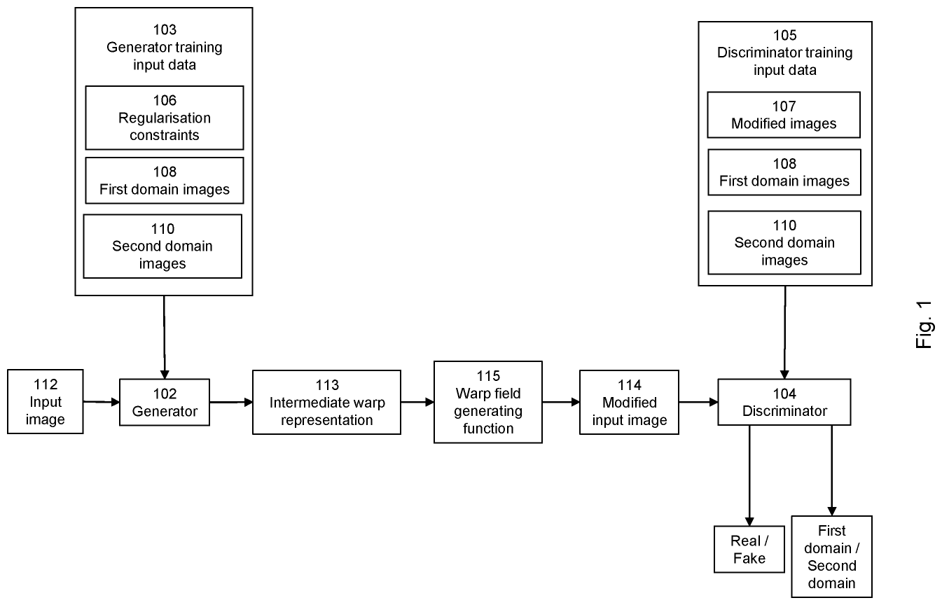

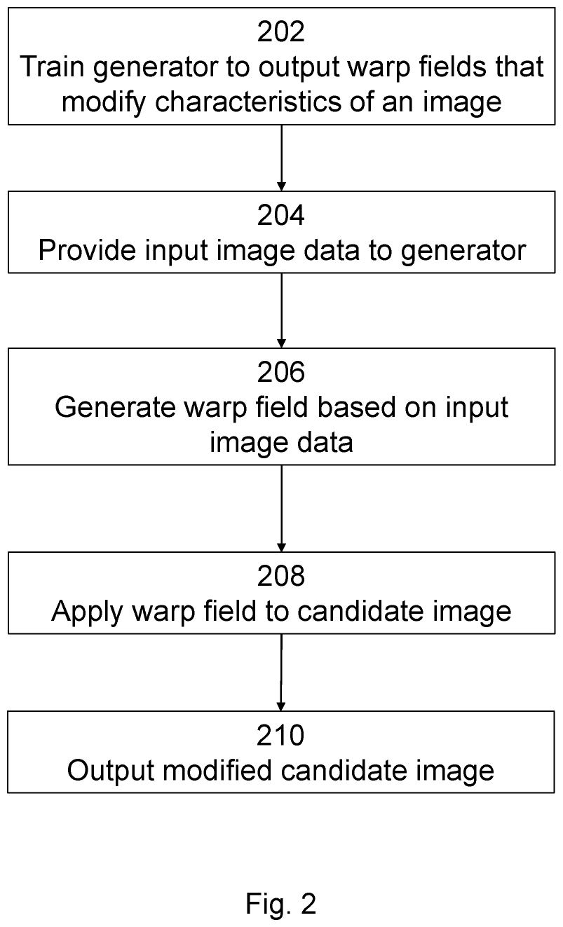

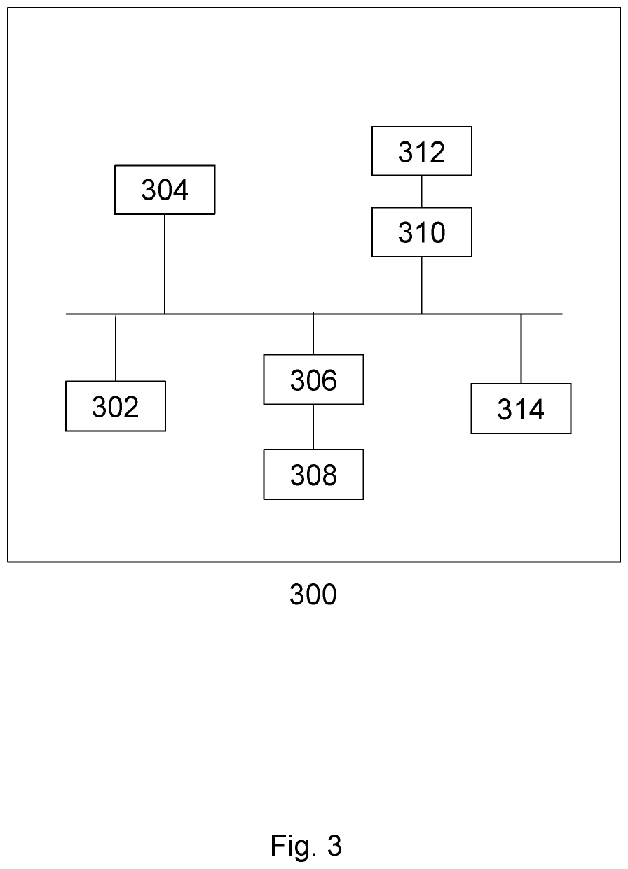

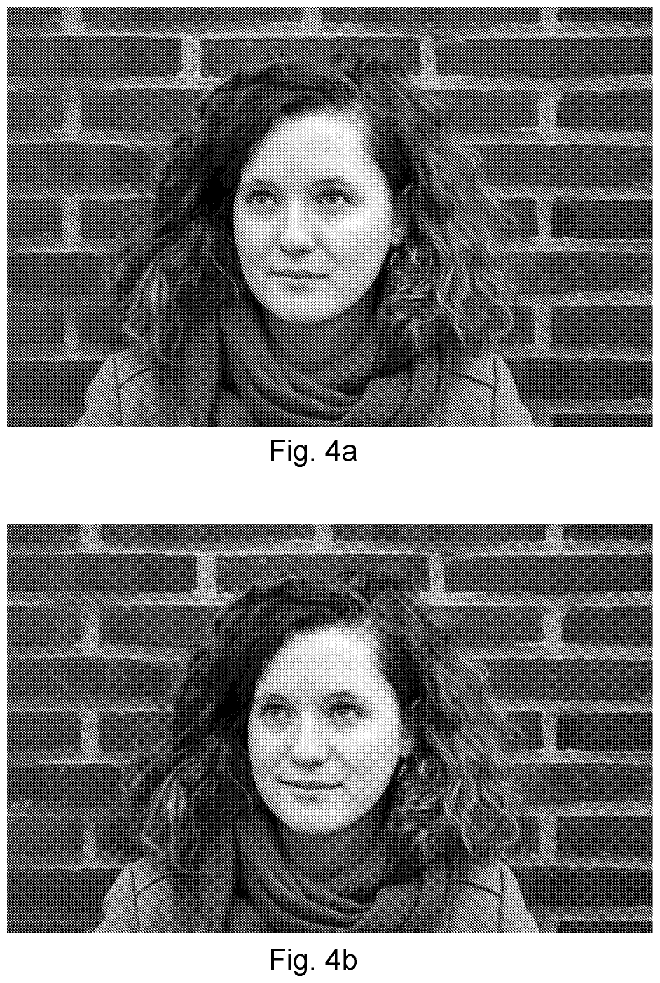

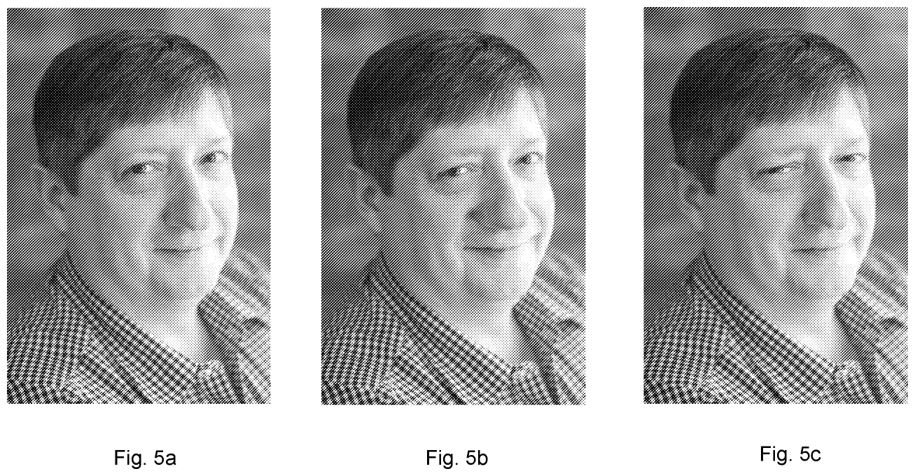

This detailed description describes, with reference to FIG. 1, a method of training a generator to output warp fields for modifying characteristics of an image. FIG. 2 is used to describe a method of modifying images using a generator trained according to the method of FIG. 1. With reference to FIG. 3, the components of a computer that can be used to implement the methods described herein, either alone or in combination with other similar computers in a network, are then described. Finally, FIGS. 4a, 4b and 5a-5c demonstrate an exemplary image modification produced by the application of the disclosed methods to an input images.

The methods disclosed herein relate generally to modifying characteristics of an image using a warp field produced by a generator 102. In the arrangements described herein the generator 102 is implemented as a computer program, in this example using a deep neural network. The computer program may be implemented in software, firmware or hardware. The generator 102 is configured to output warp fields. In order to produce said warp fields, the generator is trained using machine learning techniques. It will be appreciated that the nature of the generator will typically impact the type of procedure that is suitable for training the generator. An exemplary method of training the generator is described in relation to FIG. 1.

FIG. 1 shows an exemplary method for training a generator 102 to output warp fields that modify one or more characteristics of an input image 112 when the warp field is applied to said input image 112. A warp field can be considered as an image deformation field which describes spatially localised geometric transformations, in other words a set of displacement vectors otherwise known as offsets. When the warp field is applied to an input image 112, the displacement vectors act on corresponding pixels of the input image 112 to displace them and thus cause a modification of the input image 112. A warp field can also be considered to describe a mapping of the points (pixels) of an image from a first location (in the original image) to a second location (in the modified image). As a result of the application of a warp field to an input image 112, a modified input image 114 is produced.

The use of warp fields represents a departure from the way in which the majority of existing image modification techniques modify images. In previous approaches, the generator typically takes an existing image and constructs a high-dimensional representation (coding) of that image. From this representation, an edited image is generated. In other words, a new image is generated as a non-linear function of the original image. By contrast, the methods of the present disclosure generate a warp field which provides an explicit mapping for each pixel. The lack of an explicit mapping of this sort limits existing methods, as they are required to generate a whole new image again which frequently leads to unwanted and unrealistic modifications, as well as requiring a large amount of processing power even when applying an identity transformation, as happens when no change for one or more specific pixel is required. In contrast, when applying a warp field the identity transformation is obvious (the value in the field is zero) and the edited regions of the image are clearly discernible from the field alone.

As will be described in detail below, the generator 102 is trained using training data that comprises a plurality of images. Typically, the warp fields generated by the trained generator 102 are produced at the same resolution as the images that make up this training data. However, in contrast to the outputs of other existing methods of image manipulation, sufficiently smooth warp fields can be trivially rescaled, meaning that they are not limited to the resolution at which they are originally produced. This is in contrast to traditional images which lose sharpness, and therefore realistic texture, when the image is upscaled. Warp fields can be upscaled (or indeed downscaled) to match the resolution of essentially any image to which the warp field is to be applied. Thus, realistic image modifications can be generated for essentially any image at any resolution, regardless of the resolution of the training data used to train the generator 102 producing the warp fields.

In the present implementation, the generator 102 is trained to output warp fields that modify specific semantic characteristics of the input image 112 from a first domain to a second domain when the warp field is applied to said input image 112. The first domain can be considered as consisting of a set of images not comprising a specific semantic characteristic. For example, the first domain can comprise a set of images of human faces that are not smiling. The second domain can be considered as a set of images comprising the specific semantic characteristic not present in the first domain. For example, the second domain can comprise a set of images of human faces that are smiling. It will be apparent that the generator 102 is not limited to transforming between a first and second domain. Transformations can be between any number of domains.

In order to train the generator 102 to transform images from the first domain to the second domain, the training data used to train the generator 102 comprises a first plurality of images 108 from the first domain and a second plurality of images 110 from the second domain. In the implementation described herein the first plurality of images 108 comprises a plurality of images of people not smiling and the second plurality of images 110 comprises a plurality of images of people smiling. It will be apparent that these domains are merely exemplary, and that the disclosed methods can modify any semantic characteristic of an image. In some cases, multiple characteristics may be transformed across multiple domains. Transformations can go in any direction, for example from smiling to not smiling as well as from not smiling to smiling. The disclosed methods are also not limited to modifying images of human faces.

In order to train the generator 102, the generator 102 is incorporated into a Generative Adversarial Network (GAN), as shown in FIG. 1. The GAN depicted in FIG. 1 is a type of GAN known as a StarGAN, although it will be apparent that other GANs can be used.

The generator 102 of FIG. 1 receives generator training input data 103, which comprises regularisation constraints 106 and a dataset of real images. The dataset of images contains the first plurality of images 108 from the first domain (not smiling), and the second plurality of images 110 from the second domain (smiling) described above.

Regularisation constraints 106 restrict the type of modifications that the generator 102 can learn. In this implementation, regularisation constraints 106 restrict the generator 102 such that the generator outputs smooth warp fields, as will be described in more detail below.

The GAN further comprises a discriminator 104. In the arrangements described herein the discriminator 104 is also implemented as a computer program, in this example using a deep neural network. The computer program may be implemented in software, firmware or hardware. The discriminator 104 computer program can be implemented in the same or different software, firmware or hardware as the generator computer program. The discriminator 104 is configured to classify images into domains and discriminate between apparently real images and fake images. Real images are herein distinguished from fake images in the sense that a real image is a genuine image, for example a genuine photograph taken of a person, whereas a fake image is a modified image that has been produced through the application of a warp field to an input image.

Like the generator 102, the discriminator 104 receives input training data, in this case discriminator training input data 105. Discriminator training input data 105 comprises the first plurality of images 108 from the first domain and the second plurality of images 110 from the second domain. The discriminator training input data 105 also comprises a plurality of modified images 107, which are fake images that have been previously modified by the generator 102. Where transformation is between more than two domains, generator and discriminator training input data 103,105 comprises accordingly pluralities of images from more than two domains.

Based on the training input data 103,105, the generator 102 and discriminator 104 learn the set of attributes shared by images in each of the first 108 and second 110 pluralities of images, and thus the first and second domains, respectively. In other words, the attributes shared by images in the first plurality of images 108 are learned, and the attributes shared by images in the second plurality of images 110 are learned. Attributes that are common across both the first 108 and second 110 plurality of images are also learned, and thus attributes that are not common across both pluralities of images are also learned. The discriminator 104 also learns the attributes that are common to the plurality of modified images 107. Attributes are herein taken to mean to any feature of an image, for example pixel position, shape, area boundaries and so on. It will be apparent that the specific way in which these attributes are identified and learned will depend on the machine learning technique being applied. In the present implementation, the generator 102 and discriminator 104 are implemented in computer programs using deep neural networks, and so learn through a combination of deep learning techniques such as convolutional image filtering to create an abstract feature representation suitable for classification learned via stochastic gradient descent applied to the training data. As noted above, in some implementations the generator 102 and discriminator 104 may not be implemented in computer programs using deep neural networks and other machine learning techniques can be used to train them.

The training of the generator 102 and discriminator 104 based on the respective input training data 103, 105 will now be described in greater detail.

Turning first to the generator 102, based on the generator training input data 103, the generator 102 learns to predict an intermediate warp representation 113 that comprises a vector of numbers that can be used to define a warp field which maps the first plurality of images 108 (corresponding to the first domain) such that they appear to be from the second 110 plurality of images (corresponding to the second domain). This predicted intermediate warp representation 113 is then passed through a pre-determined warp generating function 115 to generate a warp field, consisting of a displacement vector at each image pixel. The warp field is then applied to input image 112 to produce modified input image 114.

As the intermediate warp representation 113 predicted by the generator is learned through mapping images from the first domain to the second domain, the set of displacement vectors produced that make up the warp field accordingly also correspond to a transformation from the first domain to the second. The generator 102 is thus trained to output warp fields that, when applied to an input image 112 belonging to the first domain, modify the characteristics of the input image 112 such that a modified input image 114 belonging to the second domain is produced. For example, the generator 102 learns to output warp fields that, when applied to non-smiling input images 112, produce smiling modified input images 114.

The learned intermediate warp representation 113 can encode different information depending on the corresponding warp field generating function 115 used to generate the warp field from the intermediate warp representation 113. This encoding is known as the parametrisation. For example, the intermediate warp representation 113 could be dense or sparse, in other words comprise a dense or sparse set of pixel displacement vectors.

The use of a dense intermediate warp representation 113 means that the intermediate warp representation 113 already represents a fully defined warp field. In other words, a dense set of pixel displacement vectors contains mappings from the first to the second domain for a dense set of pixels. A dense intermediate warp representation 113 therefore directly predicts all of the displacement vectors of the warp field it will produce.

Conversely, the intermediate warp representation 113 can comprise a sparse set of displacement vectors. In this case, only a small number of pixels have a pre-determined associated displacement from the generator 102. The warp field generating function 115 must therefore construct the warp field by interpolating and/or extrapolating the sparse displacement vectors of the intermediate warp representation 113 to create a dense set of pixel displacement vectors, with one displacement vector for every pixel, that make up the generated warp field.

The parametrisation can also be via a basis set that is common across all images, such as a linear basis set. In such a basis set the vector at each pixel arises as some function of a small number of weights predicted by the generator.

The warp field generating function 115 used to convert the intermediate warp representation 113 into a warp field is predefined at training time. Therefore the generator 102 at training time learns to produce an intermediate warp representation 113 that defines appropriate warp fields for the intended task of image editing, in other words the desired modification. The computational complexity of the resulting prediction and training and the flexibility of the generated warp fields will vary based on the selected intermediate warp representation 113 and thus the complexity (i.e. density) of the intermediate warp representation 113. For a sparse intermediate warp representation 113, the function 115 must interpolate this sparse intermediate warp representation 113 to produce a complete set of displacement vectors that make up the warp field. It will be appreciated that using a dense intermediate warp representation 113, in other words selecting a dense parametrisation, leads to a more complex intermediate warp representation 113. This makes the intermediate warp representation 113 more flexible, as it directly determines more of the displacement vectors that will make up the eventual warp field. However, producing a dense intermediate warp representation 113 is more computationally complex than producing a sparse intermediate warp representation 113, although this is offset somewhat by the fact that less interpolation is required to convert a dense intermediate warp representation 113 into a warp field than a sparse one.

A dense intermediate warp representation 113 contains a mapping for each pixel of the image, and therefore directly predicts the displacement vector for each pixel of the warp field that will be produced. In this case no interpolation by the warp field generating function 115 is required and so the function is simply an identity transformation and has no effect. If the intermediate warp representation 113 is sparse, then the function 115 will interpolate/extrapolate the sparse intermediate warp representation 113 to make the fully defined warp field. Typically a smooth interpolating function like a thin-plate spline might be used.

Turning now to the discriminator 104, based on the discriminator training input data 105, the discriminator 104 is trained to classify images as belonging to either the first or second domain. Training the discriminator 104 to determine the domain of an image in this manner is known as domain classification loss and typically involves attribute comparison between images from the first 108 and second 110 plurality of images.

The discriminator 104 also learns, based on the modified input images 107, to classify images as real or fake. Training the discriminator 104 to determine whether an image is real or fake in this manner is known as adversarial loss training and typically involves attribute comparison between the attributes that the discriminator 104 has learnt are common to modified images 107, the first plurality of images 108 and the second plurality of images 110. Typically the classification loss and adversarial loss training is performed at the same time.

By being incorporated into a GAN, the abilities and effectiveness of the generator 102 and discriminator 104 are refined through adversarial competition (hence the term “Generative Adversarial Network”), as will now be described.

Firstly, input image data of an input image 112 is provided to the generator 102. As will be described below, the input image data can comprise the raw image data of input image 112 and/or landmark image data obtained from input image 112.

Based on the input image data received and its training so far, the intermediate warp representation 113 learned by the generator 102 is converted by the warp field generating function 115 into a warp field designed to modify the input image from a first domain to a second domain. The warp field is then applied to input image 112 to produce modified input image 114. This process will be described more detail in relation to FIG. 2.

As a next step, modified input image 114 is provided to the discriminator 104. The discriminator 104, based on its training so far and in the same manner as described above, determines which domain it considers modified input image 114 to belong to. The discriminator 104 also determines in the same way as described above whether it considers received modified input image 114 to be a real or fake image. In practice, of course, every modified input image 114 the discriminator receives will be fake, because modified input image 114 by definition is an image to which a warp field has been applied.

For each modified input image 114 received by the discriminator 104, there are four possible outcomes. Namely, the discriminator 104 can determine that modified input image 114:

i) belongs to the first domain and is fake;

ii) belongs to the first domain and is real;

iii) belongs to the second domain and is fake; or

iv) belongs to the second domain and is real.

Where original input image 112 is an image from the first domain, outcomes i) to iii) above represent a failure by generator 102. Outcome iv) represents a success, because the generator 102 has successfully convinced the discriminator 104 that modified input image 114 belongs to domain 2 and is real, despite the fact that it is in fact fake. The outcome of this process is fed back to the generator 102 and discriminator 104 as further training data, and the process then repeats. Where the generator 102 has failed (i.e. one of outcomes i)-iii) has occurred), the generator 102 will typically try again with the same input image 112. Where the generator 102 has succeeded (i.e. outcome iv) has occurred), typically a new input image 112 is selected.

It will be apparent that by conducting many (typically tens or hundreds of thousands) of such processes with a variety of input images 112, both the generator 102 and discriminator 104 become iteratively better at their respective tasks. As discriminator 104 becomes more discerning and able to determine the domain and veracity of images, generator 102 must produce increasingly convincing modified input images (or more precisely, produce increasingly better warp fields which, when applied to input images produce convincing modified input images).

Ultimately, the end result of this process is a well-trained generator 102 that is able to reliably produce a warp field that can be applied to an arbitrary input image so as to transform the input image from a first domain to a second domain. Once the generator 102 has been optimised in this manner, any input image can be provided to the generator and edited in a single forward pass, as will be described in relation to FIG. 2. As has been emphasised already, while the described implementation relates to transformation from a first to a second domain, more complex transformations across any number of domains are possible. Typically, when the generator 102 is being trained to transform an image between more than two domains, it receives a set of target characteristics (both during training and during subsequent use) to enable it to determine which particular domain or combination of domains the modified image should belong to.

During the training process just described, as well as during subsequent image transformations once training is complete, various restrictions can be placed on the generator 102 and the GAN environment as a whole to improve the performance of the generator 102 and the quality and utility of the warp fields produced by it. During training, some of these restrictions on the generator 102 relate to regularisation and are included in the regularisation constraints 106 provided to the generator 102 in generator training input data 103.

One such regularisation-based restriction relates to the fact that, in the present implementation, the intermediate warp representation 113 learned by the generator 102 is influenced by regularisation on the predicted warp field. In particular, the warp field generated from the intermediate warp representation 113 is restricted to comprising displacement vectors that only change incrementally with respect to neighbouring pixels. In other words, the warp field is restricted to only incrementally change the relative displacement of neighbouring pixels of the image the warp field it is applied to. Thus, when the generator 102 creates a regularised warp field from an intermediate warp representation 113 using the warp field generating function 115 and this warp field is applied to an input image 112, the geometric deformations caused in the image are restricted. This means that the generator 102 is restricted to generating smooth warp fields, which is advantageous because smooth warp fields can be scaled up to arbitrarily large resolutions without impacting their performance. Thus, by regularising the warp fields produced by the generator 102 via the warp field generation function 115, it is ensured that the warp fields produced by the generator 102 perform well when scaled to high resolutions.

In the present implementation, the warp fields created by the warp generating function 115 from the intermediate warp representation 113 learnt by the generator 102 are regularised by an L2 gradient penalty loss. An L2 gradient penalty loss penalises neighbouring pixels whose relative displacements are different, thereby encouraging the generator to learn to predict warp fields that cause neighbouring pixels of the image to move similarly both in terms of direction and magnitude. It will be appreciated that any suitable regularisation or combination of regularisations can be applied in addition or alternatively to the L2 gradient penalty loss. In some implementations the relative change in position of neighbouring pixels is limited to be within a given threshold.

A further restriction applied to the generator 102 in the present implementation involves enforcing a cycle-consistency loss. Unlike many existing methods of image transformation, the methods disclosed herein do not require the training data provided to the generator 102 to consist of paired image data. Rather, any arbitrary set of images can be obtained to create the first 108 and second 110 pluralities of images that make up the training image data for the generator 102 and discriminator 104. This represents a significant improvement over existing systems where highly controlled pairs of images must be obtained in order to construct warp fields. The only requirement for the training data of the present disclosure is that a plurality of images for each relevant domain is obtained. The images can therefore be obtained with ease, for example from online image libraries.

However, one potential problem that arises when training the generator 102 and discriminator 104 with unpaired and relatively unconstrained images is that the generator 102 and discriminator 104 may find coincidental common attributes between images that are not relevant to the desired modification. This can lead to the generator 102 and discriminator 104 favouring unpredictable modifications that, while consistent with the training data they have received, do not look realistic to human viewers. To overcome this issue and thereby speed up the training process without the need for manual intervention, a cycle-consistency loss restriction is placed on the system.

The cycle-consistency loss restriction encourages the generator 102 to learn reversible intermediate warp representations 113 and therefore generate invertible warp fields. One way to determine the cycle-consistency loss is to provide modified input image 114 back into the generator 102 as an input with instructions to transform input image 114 back to the first domain. The generator then generates a second warp field accordingly, and this is applied to modified input image 114. The aim is that performing this inverse transformation will transform modified input image 114 back into something which resembles original input image 112, for example to within a threshold level of similarity. The similarity, or lack thereof, between the inversely transformed image and the original input image 112 determines the cycle-consistency loss. A large cycle-consistency loss represents that the inversely transformed image has a large disparity when compared with original input image 112. Conversely, a small cycle-consistency loss represents the opposite, i.e. an inversely transformed image having a small disparity when compared with original input image 112.

An alternative method for determining the cycle-consistency loss is to compare the initial warp field, generated to transform input image 112 into modified input image 114, with an inverse warp field, generated to transform modified input image 114 back into modified input image 112. The aim is that the product of these two warp fields is the identity transform, as this indicates that the two warp fields are exact inverses of one another (i.e. that the warp fields are invertible) and that the cycle-consistency loss is zero. This method of determining the cycle-consistency loss is simpler, as it does not require the inverse warp field to actually be applied to modified input image 114.

Once the cycle-consistency loss is determined, it is fed back into the learning of the generator 102 such that it attempts to minimise this loss across the training input image 112. A high cycle-consistency loss is penalised such that the generator 102 is configured to preferentially predict intermediate warp representations 113 in future that have resulted in a low cycle-consistency losses in the past. In other words, the generator 102 is trained to tend towards learning reversible intermediate warp representations 113, and thereby invertible warp fields. This helps to ensure that the application of warp fields generated by the generator 102 preserves the information of the original images and produces realistic looking modified images. An additional advantage of configuring the generator 102 to preferentially generate invertible warps in this manner is that invertible warps are by definition smooth and can therefore be upscaled to arbitrarily high resolutions. The effectiveness of the training process is also improved, as encouraging the generator 102 to output invertible warps effectively leads it to solve a dual learning problem, and the insights gained by the generator 102 through this process are useful for enabling it to improve its main goal of producing warp fields that produce convincing modifications.

So far, a method for training a generator 102 to output warp fields that modify one or more characteristics of an input image 112 has been described, along with various restrictions that can be placed on the generator 102 and training system as a whole to improve the quality of the eventual modified output images. It will be apparent that, once the generator 102 is adequately trained, it can be used to modify characteristics of any input image in a single pass through the model, and therefore within a fixed computational budget. This process will now be described in detail with reference to FIG. 2.

FIG. 2 shows a method of using a generator 102, trained in the manner described above, to produce a warp field that warps an input image from a first domain to a second domain. Advantageously, once the generator 102 has been trained, the method of FIG. 2 can be carried out in a single pass. This is in contrast to some existing techniques that require several iterations before a satisfactory output image is produced.

At block 202, the generator 102 is trained to output warp fields that modify characteristics of an image. An exemplary method for training the generator 102 in this way has been described above in relation to FIG. 1.

Once trained, the generator 102 can be used to modify any desired image, based on the warp field created using generator 102. Thus, a new input image 112 is selected. In this example, the generator 102 has been trained to transform images from a first domain, comprising non-smiling human faces, to a second domain, comprising smiling human faces. Therefore, the new input image 112 in this example is an image of a non-smiling human face.

At block 204, image data of the new input image is provided to the generator 102. In this implementation, the input image data comprises facial “landmark” data obtained from the input image 112. Facial landmark recognition is well-known and so the precise methods by which these landmarks are detected and obtained will not be described in detail here. However, in brief, various landmarks of the face in the input image 112 are detected. These can include, for example, the contours and/or positions of key aspects of the subject's face, for example the mouth, nose and eyes. These locations are then recorded and make up part of the input image data.

In the present implementation the input image data comprises the landmark data as well as the raw input image data. However, it will be appreciated that limiting the input image data provided to the generator 102 to only or primarily landmark data reduces the amount of data that needs to be transmitted to and processed by the generator 102, so in some implementations this can be done. It will also be appreciated that the use of landmark image data is not essential and in some implementations the input image data may comprise only the raw image data.

It will be appreciated that, if landmark recognition is being used, then training of the generator 102 and discriminator 104 can also be based on landmark data in combination with or as an alternative to raw image data. In other words, the training input data 103,105 provided to the generator 102 and discriminator 104 during training can comprise landmark image data of the images in the first 108 and second 110 pluralities of training images as well as the plurality of modified images 107, instead of or in addition to the raw image data of these images.

In implementations where the generator 102 is transforming between more than two domains, a set of target characteristics is provided to the generator 102 with the input image data, which enables the generator 102 to determine which domain or combination of domains is the target domain(s) to which the input image should be modified into.

In this implementation, the input image data is aligned with the training data that has been used to train generator 102, prior to providing the input image data to the generator 102. The plurality of images making up the training data itself are also aligned. It will be appreciated that aligning the training data and the input image data in this way makes it easier for the generator 102 to determine an appropriate set of attributes to describe the input image data and thereby produce intermediate warp representations 113 that create high quality warp fields. However, such alignment is not essential. In this implementation aligning the input image data comprises performing an affine transformation on the input image data. Other linear and non-linear transformations can be used. Aligning the input image data in this implementation also comprises changing the resolution of the input image data to match the resolution of the training data. The resolution of the input image data is typically resized bilinearly. As explained previously, the resolution of the training data is typically lower than the original resolution of the input image data, because the resolution of training data images must typically be restricted to avoid placing an unmanageable computational burden on the training environment.

Once the input image data has been aligned with the training data, the generator 102 then generates, at block 206, a warp field based on the input image data. As described above, generation of the warp field at this stage comprises the conversion of an intermediate warp representation 113 based on the input image data into a warp field. Generation of the intermediate warp representation 113 is informed by the generator's training (in particular the intermediate warp representations 113 it has constructed previously, and how well these have performed). The conversion of the intermediate warp representation 113 into a warp field is performed by passing the intermediate warp representation 113 through a warp field generating function 115.

In implementations where a set of target characteristics is provided to the generator 102, the warp field is generated based on the input image data and the set of target characteristics. A candidate image to be modified is selected and the warp field is applied, at block 208, to the candidate image to create a modified candidate image. Application of the warp field to the candidate image can be by the generator 102 or any other computer system. In this implementation, the warp field is aligned with the candidate image before being applied to the candidate image, in the same way as the input image data is aligned with the training data. Aligning the warp field with the candidate image in this implementation comprises changing the resolution of the warp field match the resolution of the candidate image. It will be appreciated that this second alignment step, as in the case of the first alignment step described above, is optional. Once the warp field has been applied to the candidate image, the resulting modified candidate image is output at block 210.

It will be appreciated that, typically, the candidate image to which the generated warp field is applied at block 208 will be original input image 112, because the warp field has been generated based on input image data from input image 112 and so is likely to perform best when applied to this image. However, the generated warp field can, at block 208, also or alternatively be applied to any other image, in other words the candidate image does not necessarily need to be original input image 112. For example, a warp field generated based on an input image 112 of a particular person could be applied to a different image of the same person and may still produce reasonable results. Throughout the remaining description, however, it is assumed for simplicity that the candidate image to which the warp field is applied is original input image 112, and so the modified output image is modified input image 114. Where the input image 112 is the candidate image, the alignment of the warp field with the candidate image represents an inverse alignment transformation compared with the alignment transformation applied when aligning the input image data with the training data.

As described previously, the warp field generated in this process, at block 206, comprises a set of geometric displacement vectors. In this example, the set of geometric displacement vectors are designed by the generator 102 to modify input image 112 from the first domain to the second domain, when the warp field is applied to input image 112. In other words, the warp field is designed such that application of the warp field to input image 112 produces modified input image 114 (i.e. an output image), where original input image 112 belongs to the first (non-smiling) domain and modified input image 114 belongs to the second (smiling) domain.

Typically the warp field is generated by the generator 102 at the resolution of the training data, i.e. the images in the first 108 and second 110 plurality of images that were used to train generator 102. Advantageously, however, the warp field if sufficiently smooth can be upscaled, typically bilinearly, to the resolution of whatever candidate image it is to be applied to at block 208. For example, in the typical case where the warp field is to be applied to original input image 112, the warp field can be rescaled to the resolution of input image 112 before it is applied. This represents a marked improvement over existing systems, where transformations can only be applied at the resolution of the training data used to train the generator.

Turning now to FIG. 3, FIG. 3 shows a schematic and simplified representation of a computer system 300 which can be used to perform the methods described herein, either alone or in combination with other computer systems. An exemplary combination of computer systems 300 is a neural network, such as a deep neural network. When a plurality of computer systems are used to perform the methods described herein, for example when networks such as deep neural networks are utilised, this plurality of computer systems can each have the general structure of computer system 300.

The computer system 300 comprises various data processing resources such as a processor 302 coupled to a central bus structure. Also connected to the bus structure are further data processing resources such as memory 304. A display adapter 306 connects a display device 308 to the bus structure. One or more user-input device adapters 310 connect a user-input device 312, such as a keyboard and/or a mouse to the bus structure. One or more communications adapters 314 are also connected to the bus structure to provide a connections to other computer systems 300 and other networks.

In operation, the processor 302 of computer system 300 executes a computer program comprising computer-executable instructions that may be stored in memory 304. When executed, the computer-executable instructions may cause the computer system 300 to perform one or more of the methods described herein. The results of the processing performed may be displayed to a user via the display adapter 306 and display device 308. User inputs for controlling the operation of the computer system 300 may be received via the user-input device adapters 310 from the user-input devices 312.

It will be apparent that some features of computer system 300 shown in FIG. 3 may be absent in certain cases. For example, where a plurality of computer systems 300 make up a network, such as a deep neural network, one or more of the plurality of computer systems 300 may have no need for display adapter 306 or display device 308. Similarly, user input device adapter 310 and user input device 312 may not be required. In its simplest form, computer system 300 comprises processor 302 and memory 304.

Turning finally to FIGS. 4a, 4b and 5a-5c, these figures show exemplary image modifications achieved using the disclosed methods.

FIG. 4a is a real image belonging to a first domain which in this example comprises non-smiling human faces. FIG. 4b is a fake image belonging to a second domain which in this example comprises smiling human faces. FIG. 4b was created by applying the methods disclosed herein to FIG. 4a.

More specifically, a generator was trained according to the method described in relation to FIG. 1 to generate warp fields that modify images from a first (non-smiling) domain to a second (smiling) domain. The image shown in FIG. 4a was then used as an input image according to the method described in relation to FIG. 2. Input image data comprising facial landmark data of the input image was obtained and aligned with the training data used to train the generator. The aligned input image data was then provided to the generator. Based on this input image data, the generator produced a warp field designed to modify the input image from the first to the second domain. The warp field was applied to the input image (i.e. the image shown in FIG. 4a). The resulting modified output image is the image in FIG. 4b.

As can be seen, the output image (i.e. FIG. 4b) now belongs to the second (smiling) domain and is a realistic depiction of the person from the input image (FIG. 4a) smiling. Notably, the image shown in FIG. 4a, to which the warp field was applied, is of a significantly higher resolution than the training data on which the generator was trained. The generator was also trained on unpaired data obtained from online image libraries. None of the training data provided to the generator contained the image shown in FIG. 4a or any other images of the person shown in FIG. 4a.

FIG. 5a is a different real image belonging to a different first and second domain which in this example comprise human faces with small noses and open (non-narrowed) eyes respectively. FIGS. 5b and 5c show different image modifications achieved through the application of different warp fields to the image of FIG. 5a.

FIG. 5b is a fake image belonging to a third domain which in this example comprises human faces with large noses. FIG. 5b was created by applying the methods disclosed herein to FIG. 5a. FIG. 5c is a different fake image belonging to a fourth domain which in this example comprises human faces with narrowed eyes. FIG. 5c was also created by applying the methods disclosed herein to FIG. 5a. As in the case of FIG. 4a, the image shown in FIG. 5a is of a significantly higher resolution than the training data on which the generator was trained. The generator was also trained on unpaired data obtained from online image libraries. None of the training data provided to the generator contained the image shown in FIG. 5a or any other images of the person shown in FIG. 5a.

In summary, and as can be seen in FIGS. 4b, 5b and 5c in particular, the disclosed methods produce realistic image modifications at high resolutions and without any need for paired or controlled training data. This represents a significant improvement over known image modification systems.

The described methods may be implemented using a computer program comprising computer executable instructions. A computer program product or computer readable medium may comprise or store the computer program. The computer program product or computer readable medium may comprise a hard disk drive, a flash memory, a read-only memory (ROM), a CD, a DVD, a cache, a random-access memory (RAM) and/or any other storage media in which information is stored for any duration (e.g., for extended time periods, permanently, brief instances, for temporarily buffering, and/or for caching of the information). The computer readable medium may be a tangible or non-transitory computer readable medium. The term “computer readable” encompasses “machine readable”.

In the foregoing, the singular terms “a” and “an” should not be taken to mean “one and only one”. Rather, they should be taken to mean “at least one” or “one or more” unless stated otherwise. The word “comprising” and its derivatives including “comprises” and “comprise” include each of the stated features but does not exclude the inclusion of one or more further features.

The above implementations have been described by way of example only, and the described implementations are to be considered in all respects only as illustrative and not restrictive. It will be appreciated that variations of the described implementations may be made without departing from the scope of the invention. It will also be apparent that there are many variations that have not been described, but that fall within the scope of the appended claims.

1. A computer-implemented method for training a generator to manipulate one or more characteristics of an image, the method comprising:
training a generator to output warp fields that modify one or more characteristics of an image, wherein training the generator comprises use of a Generative Adversarial Network (GAN) and training data comprising a plurality of images.

2. A computer-implemented method for manipulating one or more characteristics of an image, the method comprising:
receiving input image data from an input image at a trained generator, wherein the generator is trained, through use of a Generative Adversarial Network (GAN) and training data comprising a plurality of images, to output warp fields that modify one or more characteristics of an image;
generating, by the trained generator and based on the input image data, a warp field;
applying the warp field to a candidate image to modify one or more characteristics of the candidate image; and
outputting the modified candidate image.

3. A computer-implemented method for manipulating one or more characteristics of an image, the method comprising:
training a generator to output warp fields that modify one or more characteristics of an image, wherein training the generator comprises use of a Generative Adversarial Network (GAN) and training data comprising a plurality of images;
providing input image data from an input image to the trained generator;
generating, by the trained generator and based on the input image data, a warp field;
applying the warp field to a candidate image to modify one or more characteristics of the candidate image; and
outputting the modified candidate image.

4. The method of claim 2, wherein modifying one or more characteristics of the candidate image comprises transforming one or more characteristics of the candidate image from a first domain to a second domain.

5. The method of claim 4, wherein the training data comprises a plurality of images each having image characteristics from either the first domain or the second domain.

6. The method of claim 2, further comprising aligning the input image data with the training data prior to providing/receiving the input image data to/at the trained generator.

7. The method of claim 6, wherein aligning the input image data with the training data comprises modifying the resolution of the input image data from a first resolution to a second resolution, wherein the second resolution is the resolution of the training data.

8. The method of claim 6, further comprising aligning the warp field with the candidate image prior to applying the warp field to the candidate image.

9. The method of claim 8, wherein aligning the warp field with the candidate image comprises modifying the resolution of the warp field from the second resolution to a third resolution, wherein the third resolution is the resolution of the candidate image.

10. The method of claim 9, wherein the third resolution is the same as the first resolution.

11. The method of claim 2, wherein the candidate image is the same as the input image.

12. The method of claim 2, wherein the input image data comprises landmark image data associated with the input image.

13. The method of claim 2, wherein the warp field is regularised such that the warp field is restricted to comprising displacement vectors that change incrementally with respect to displacement vectors at neighbouring pixels.

14. The method of claim 13, wherein the warp field is regularised by an L2 gradient penalty loss.

15. The method of claim 2, wherein the warp field is parametrised by either:
an offset per pixel; or
offsets for a sparse set of control points.

16. The method of claim 2, wherein at least one of the input image and the candidate image comprises a human face.

17. The method of claim 1, wherein training the generator to output warp fields further comprises performing, by the GAN, cycle-consistency checks.

18. The method of claim 17, wherein the GAN is a StarGAN.

19. The method of claim 1, wherein the generator is implemented as a computer program using a neural network.

20. Computer-executable instructions which, when executed on one or more computers, cause the one or more computers to perform the method of claim 1.

21. A computer system comprising one or more computers having a processor and memory, wherein the memory comprises computer-executable instructions which, when executed, cause the one or more computers to perform the method of claim 1.
